(19) United States
(12) Patent Application Publication
(10) Pub. No.: US 2008/0210158 A1
(43) Pub. Date: Sep. 4, 2008

(54) Device for Applying a Liquid Dopant Solution on a Wafer

(76) Inventor: Adolf Munzer, Unterschleissheim (DE)

Correspondence Address: MCGLEW & TUTTLE, PC, P.O. BOX 9227, SCARBOROUGH STATION, SCARBOROUGH, NY, 10510-9227, US

(21) Appl. No.: 10/597,651

(22) PCT Filed: Feb. 11, 2005
(86) PCT No.: PCT/EP05/50611

§ 371 Date: Aug. 2, 2006

(30) Foreign Application Priority Data
Feb. 13, 2004 (EP) 04003270.8

(51) Int. Cl. B05C 1/08

(52) U.S. Cl. 118/258

(57) ABSTRACT

Device (1) for applying a liquid dopant solution on a wafer (3), comprising a dopant distribution device (5), a rotatable horizontally translatable dopant-transfer roll (7) between a first roll position (15) and a second roll position, and a work table (9) for holding the wafer (3), wherein the distribution device (5) comprises a dopant-transfer block (20) and a fluid container (24) having an open side enclosed by an edge (26), which open side is directed to the dopant-transfer block (20), wherein the block holder (21) is horizontally translatable between a first block position in which the dopant-transfer block is under the open side of the fluid container and a second block position (31) in which the dopant-transfer block (20) has contacted the rotatable dopant-transfer roll (7) in its first roll position (15), wherein during normal operation in the second roll position the rotatable dopant-transfer roll (7) has contacted the wafer (3) to provide dopant solution onto the surface of the wafer (3).

The present invention relates to applying a liquid dopant solution on the surface of a wafer. Such a wafer is suitably a silicon wafer used in manufacturing a photovoltaic cell.

When a wafer is used in manufacturing a photovoltaic cell, it is provided with a bulk doping. One of the two surfaces of the wafer is designated as light receiving surface, and the side of the wafer is the light receiving side. At its light receiving side the wafer is provided with a thin layer having a doping that differs from the bulk doping. The transition between the bulk and the thin region is called a junction.

There is a tendency to apply a doping as well on the backside of the wafer (the side of the wafer opposite the light receiving side). This is done to create a so-called back surface field, which is a build-in electric field on the backside that deflects minority carriers and reduces the recombination rate at the back surface.

A thin doped layer at the light receiving side of the wafer or at its back side can be obtained in three ways: (1) depositing the dopant in gaseous form at elevated temperature and allowing the gaseous dopant to diffuse into the wafer, (2) applying a dopant-containing paste on the surface of the wafer and heating the wafer to cause the dopant to diffuse into the wafer, and (3) applying a liquid dopant solution on the surface of the wafer and heating the wafer with the dopant solution on it to evaporate the solvent and to cause the dopant to diffuse into the wafer.

Applying a liquid dopant solution can be done with different techniques, which are discussed in U.S. Pat. No. 5,972,784. One technique is spraying the liquid dopant solution on the surface of a wafer, another technique is dropping a small volume of liquid dopant solution on the surface of a spinning wafer and allowing the liquid dopant solution to spread evenly over the surface, and a third technique is dipping the wafer in a dopant solution.

The present invention is also concerned with applying the liquid dopant solution on the surface of a wafer.

The production rate, which is the number of wafers that can be provided with the dopant solution, of the known techniques is low. In order to reduce the costs of solar energy a higher production rate is required.

It is an object of the present invention to provide a device for applying a liquid dopant solution on the surface of a wafer that allows a high production rate.

To this end the device for applying a liquid dopant solution on the surface of a wafer, which device comprises a dopant distribution device, a rotatable dopant-transfer roll horizontally translatable in a direction perpendicular to the axis of rotation of the dopant-transfer roll between a first roll position and a second roll position, and a work table for holding during normal operation the wafer to be provided with the dopant solution, wherein the dopant distribution device comprises a dopant-transfer block supported by a block holder and a fluid container having an open side enclosed by an edge, which open side is directed to the dopant-transfer block and which edge cooperates with the dopant-transfer block, the block holder or both to prevent leaking of dopant solution, wherein the block holder and the fluid container can be displaced relative to each other, wherein the block holder is horizontally translatable in a direction perpendicular to the axis of rotation of the dopant-transfer roll between a first block position in which the dopant-transfer block is under the open side of the fluid container and a second block position in which the dopant-transfer block has contacted the rotatable dopant-transfer roll in its first roll position, wherein during normal operation in the second roll position the rotatable dopant-transfer roll has contacted the wafer to provide dopant solution onto the surface of the wafer.

For the sake of completeness reference is made to USA patent specification No. 4 557 195. This publication relates to a device for printing an object, which device includes a device for inking a printing block. The known device comprises an ink distribution device comprising a printing block supported by a block holder and an ink container having an open side enclosed by an edge, which open side is directed to the printing block and which edge cooperates with the printing block and the block holder to prevent leaking of ink, wherein the block holder and the ink container can be displaced relative to each other, wherein the block holder is horizontally translatable between a first block position in which the printing block is under the open side of the ink container and an exposed position in which the printing block is free from the fluid container.

During normal operation, the printing block (also called cliché), which is engraved, is kept stationary, and the ink container displaced from the first position, in which the printing block is inked, to the exposed position. In the exposed position, a rubber pad is pressed on the printing block to accept the ink from the printing block. After accepting the ink, the pad is turned away to print an object.

An alternative to the above device is disclosed in International patent application publication No. 93/09 950. The device disclosed in this publication differs from the above-described device for inking a printing block in that during normal operation the printing block is kept stationary and the ink container is displaced relative to the printing block.

Reference is further made to International patent application publication No. 02/08 243. This publication relates to applying a thin layer on a substrate by means of screen-printing using a screen in the form of a continuous band.

Reference is further made to International patent application publication No. 02/061 854. This publication relates to a method of structuring an oxide layer applied to a substrate, wherein in accordance with the screen-printing method a paste is applied on the oxide layer, which paste contains a component for etching an oxide, and wherein the printed paste is removed after having acted for a predetermined on the oxide layer.

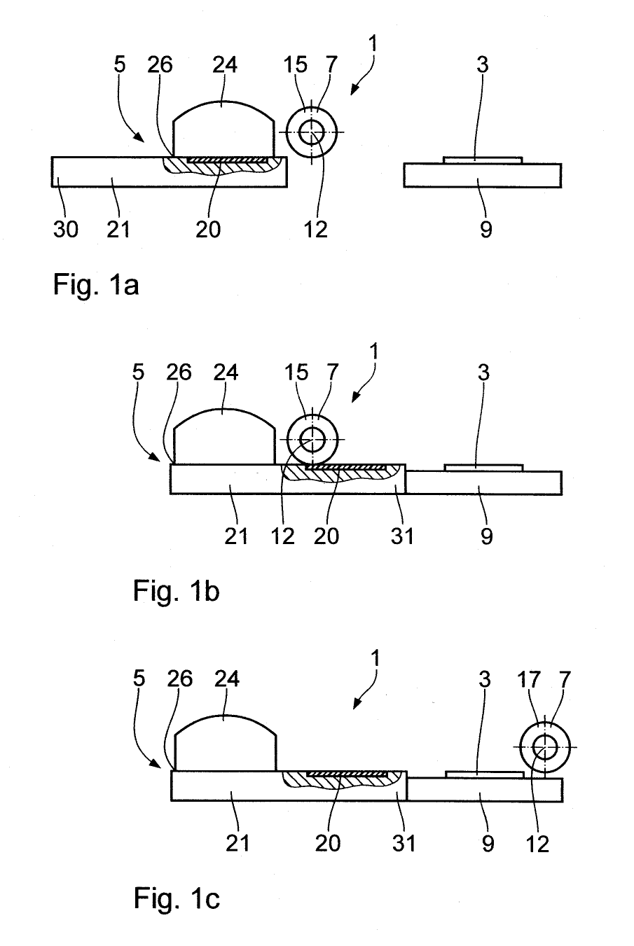

The invention will now be discussed by way of example in more detail with reference to the accompanying drawing, wherein FIGS. 1a, 1b and 1c show schematically and not to scale the device for applying a liquid dopant solution according to the present invention in three different operation positions.

The device 1 for applying a liquid dopant solution on the surface of a wafer 3 comprises a dopant distribution device 5, a rotatable dopant-transfer roll 7, and a worktable 9 for holding during normal operation the wafer 3 to be provided with the dopant solution.

The rotatable dopant-transfer roll 7 is horizontally translatable in a direction perpendicular to the axis of rotation 12 of the dopant-transfer roll 7 between a first roll position 15 and a second roll position 17. Please note that the axis 12 extends perpendicular to the plane of drawing.

The distribution device 5 comprises a dopant-transfer block 20 supported by a block holder 21 and a fluid container 24 having an open lower side enclosed by a sealing edge 26. The open side is directed to the dopant-transfer block 20. The sealing edge 26 cooperates with the dopant-transfer block 20, the block holder 21 or with both the dopant-transfer block 20 and the block holder 21 to prevent leaking of dopant solution.

The block holder 21 supporting the dopant-transfer block 20 and the fluid container 24 can be displaced relative to each other. The block holder 21 is horizontally translatable in a direction perpendicular to the axis of rotation 12 of the dopant-transfer roll 7 between a first block position 30 in which the dopant-transfer block 20 is under the open side of the fluid container 24 and a second block position 31 in which the dopant-transfer block 20 has contacted the rotatable dopant-transfer roll 7 in its first roll position 15.

The second roll position 17 of the rotatable dopant-transfer roll 7 is so selected that in the second roll position 17 the dopant-transfer roll 7 has contacted the wafer 3 to provide dopant solution onto the surface of the wafer 3.

Means for supporting and guiding the block holder 21 and the dopant-transfer roll 7 and means for supporting the worktable 9 are not shown in the Figures.

During normal operation, a wafer 3 to be provided with a dopant solution is secured on the worktable 9. The fluid container 24 is filled with dopant solution. The block holder 21 is in its first block position 30 and the dopant-transfer roll 7 is in its first position 15. In its first position the block 20 is under the open side of the fluid container and dopant solution can wet the dopant-transfer block 20. This initial position is shown in FIG. 1a.

Then the block holder 21 is translated horizontally in a direction perpendicular to the axis of rotation 12 of the dopant-transfer roll 7 from the first block position 30 to the second block position 31 in which the dopant-transfer block 20 has contacted the rotatable dopant-transfer roll 7 in its first roll position 15. This position is shown in FIG. 1b. The sealing edge 26 cooperating with the block 20, the block holder 21 or with both prevents leakage of the dopant solution.

During the translation of the block holder 21, the dopant-transfer roll 7 is lifted up so that the dopant-transfer block 20 moves under the dopant-transfer roll 7. The size of the dopant-transfer block 20 in the direction of its translation is at least equal to the circumference of the dopant-transfer roll 7.

Then the rotatable dopant-transfer roll 7 is lowered so as to bring it into contact with the dopant-transfer block 20, and then the rotatable dopant-transfer roll 7 is translated horizontally in a direction perpendicular to the axis of rotation 12 of the dopant-transfer roll 7 from the first roll position 15 to the second roll position 17. In the second roll position 17 the dopant-transfer roll 7 has contacted the wafer 3 to provide dopant solution onto the surface of the wafer 3. This is the final position and it is shown in FIG. 1c.

During part of the translation, the dopant-transfer roll 7 moves over and in contact with the dopant-transfer block 20, and dopant solution is transferred unto the dopant-transfer roll 7. The dopant solution on the dopant-transfer roll 7 is during the last part of the translation transferred on the surface of the wafer 3 that is to be provided with dopant solution. Suitably the circumference of the dopant-transfer roll 7 is about equal to the size of the wafer 3 in the direction of translation of the dopant-transfer roll 7.

Then the dopant-transfer roll 7 and the block holder 21 return to their respective first positions, as shown in FIG. 1a, the wafer 3 provided with the dopant solution is removed and a new wafer is put in the worktable.

It will be understood that the initial position as shown in FIG. 1a can also be reached by returning the block holder 21 to the first block position 30 simultaneously with translating the dopant-transfer roll 7 to the second roll position 17, after which the dopant-transfer roll 7 is returned to the first roll position 15.

Suitably, the dopant-transfer block 20 is made of plastic, steel or a ceramic material and it is provided with a suitable structure. The dopant-transfer roll 7 is suitably made of a silicone rubber.

The surface of the wafer on which the dopant solution is applied can be a flat surface or a structured surface.

The device according to the present invention allows doping about 1 000 wafers per hour. Moreover, the present invention allows applying a thin uniform layer of the dopant solution, wherein the thickness of the layer of dopant solution is between 1 and 10 micrometer. The layer can be applied over a large surface area (more than 100 cm²) and on thin wafers (less than about 100 micrometers).

1. A device (1) for applying a liquid dopant solution on the surface of a wafer (3), which device (1) comprises a dopant distribution device (5), a rotatable dopant-transfer roll (7) horizontally translatable in a direction perpendicular to the axis of rotation (12) of the dopant-transfer roll (7) between a first roll position (15) and a second roll position (17), and a work table (9) for holding during normal operation the wafer (3) to be provided with the dopant solution, wherein the dopant distribution device (5) comprises a dopant-transfer block (20) supported by a block holder (21) and a fluid container (24) having an open side enclosed by an edge (26), which open side is directed to the dopant-transfer block (20) and which edge (26) cooperates with the dopant-transfer block (20), the block holder (21) or both to prevent leaking of dopant solution, wherein the block holder (21) and the fluid container (24) can be displaced relative to each other, wherein the block holder (21) is horizontally translatable in a direction perpendicular to the axis of rotation (12) of the dopant-transfer roll (7) between a first block position (30) in which the dopant-transfer block (20) is under the open side of the fluid container (24) and a second block position (31) in which the dopant-transfer block (20) has contacted the rotatable dopant-transfer roll (7) in its first roll position (15), wherein during normal operation in the second roll position (17) the rotatable dopant-transfer roll (7) has contacted the wafer (3) to provide dopant solution onto the surface of the wafer (3).
